(19) United States
(12) Patent Application Publication
(10) Pub. No.: US 2016/0003067 A1
(43) Pub. Date: Jan. 7, 2016

(54) Aluminum Fan Blades with Root Wear Mitigation

(71) Applicant: UNITED TECHNOLOGIES CORPORATION, Hartford, CT (US)

(72) Inventors: Curtis H. Riewe, Manchester, CT (US); Melvin Freling, West Hartford, CT (US); Randy P. Salva, Baltic, CT (US)

(21) Appl. No.: 14/769,006

(22) PCT Filed: Dec. 13, 2013
(86) PCT No.: PCT/US2013/075019

§ 371 Date: Aug. 19, 2015

Related U.S. Application Data
(60) Provisional application No. 61/774,083, filed on Mar. 7, 2013.

(51) Int. Cl. F01D 5/28; F01D 5/02; F01D 25/18; F01D 5/30

(52) U.S. Cl. CPC F01D 5/288; F01D 5/3007; F01D 5/02; F01D 25/18; F05D 2220/32; F05D 2230/60; F05D 2230/90

(57) ABSTRACT

A fan blade assembly with wear mitigation characteristics is disclosed. In a titanium hub, dovetail shaped slots are used for accommodating dovetail shaped roots of fan blades. At least the inwardly facing walls of the dovetail shaped slots are coated with a dry film lubricant. The inwardly directed pressure faces of the dovetail shaped root of the fan blades are covered with polymeric wear mitigation pads. The combination of wear mitigation pads on the pressure faces of the root of the fan blade in combination with a dry film lubricant coating on the inwardly directed walls of the dovetail shaped slots in the hub provide excellent wear mitigation characteristics and prolong the life of the fan blades.

### CROSS-REFERENCE TO RELATED APPLICATIONS

This patent application is a 35 USC §371 U.S. national stage filing of International Patent Application No. PCT/US13/75019 filed on Dec. 13, 2013, which claims priority under the 35 USC §119(e) to U.S. Provisional Patent Application Ser. No. 61/774,083, filed on Mar. 7, 2013.

### TECHNICAL FIELD

This disclosure relates to aircraft that include fan blades mounted to a rotating hub. More specifically, this disclosure relates to fan blades coupled to slots in a hub with wear resistance means and lubricant means to protect the fan blade root and the hub from wear, to prolong the working life of the fan blade and hub and/or to extend the time period before the roots of the fan blades or slots in the hub require maintenance.

### BACKGROUND

Turbofan gas turbine engines may be used to power aircraft. Such engines may employ fan blades attached to a hub mounted on the forward (upstream) end of one of the engine shafts. Typically, the fan blades may include a radially outwardly extending airfoil portion and a inner root portion that may have a dovetail shape. The dovetail shaped root portion may be received within a dovetail shaped slot in the fan hub. The slot may be slightly larger than the root to facilitate attaching the fan blade to the hub by sliding the root into the slot and removing blade from the hub by sliding the root of the blade out of the slot. The difference in dimensions between the root and the slot may provide a clearance between the root and the slot. Under normal operating conditions when the engine's rotor is spinning at high speed (several thousand rpm), the centrifugal force acting on the fan blade causes the root of the fan blade to be held tightly in the hub slot.

However, when the engine is not in use, wind acting on the fan blades can cause the engine's rotor to slowly turn. This slow turning of the engine rotor in response to wind acting on the fan blades is referred to as windmilling. There is very little centrifugal force acting on the fan blades during such windmilling due to the low rotational speed of the engine rotor and thus, the roots are not tightly held within the slots, resulting in movement of the fan blade roots within the hub slots. This movement of the roots within the slots, if unchecked, can result in damage to the roots and/or the slots from galling and fretting of the surfaces of the roots and the slots. To minimize such galling and fretting, it has been a practice to employ spacers between the radially-inward facing surface of the root, or the inner face of the root, and the radially-outward facing surface of the slot, or inner surface of the slot. The spacers help to prevent movement of the root within the slot during windmilling of the engine rotor. In some cases, the spacers may resiliently bias the root and thus the entire blade radially outwardly to tightly secure the root within the slot.

The bias of the spacer against the inner face of the root causes the inwardly slanted portions of the dovetail root, often referred to as the pressure faces, to frictionally engage the corresponding inwardly slanted walls of the dovetail slot. Further, as discussed above, normal operation of the engine at several thousand rpm creates significant centrifugal forces that increase this frictional engagement. Consequently, the frictional engagement between the pressure faces of the root and the slanted walls of the slot will cause increased wear on the pressure faces of the root and the slanted walls of the slots in the hub, which can reduce the service life of the fan blade and/or hub. Thus, there is a need to mitigate the wear incurred on pressure faces of dovetail roots of fan blades that are received within dovetail slots of titanium hubs.

Finally, in the event one or more birds engage the fan blades during operation of the engine, the fan blades are susceptible to substantial damage including cracking and breaking off of significant portions of the individual blades. This damage may be exacerbated by the fan blades being securely held in place by the action of centrifugal forces and/or spacers between the hub slots and the fan blade roots. It would be advantageous to enable the fan blade to slide or move within the slot in the event of bird impact. Even a minimal amount of sliding may reduce the possibility of the airfoil breaking as a result of bird impact. Thus, there is a need to allow for movement of the roots of the fan blades within the slots of the hub to alleviate damage caused by bird impact.

### SUMMARY

In one aspect, a fan blade assembly is disclosed. The fan blade assembly may include a disc shaped hub that may include an outer periphery with a plurality of circumferentially spaced dovetail shaped slots that extend radially inwardly through the outer periphery of the hub. Each slot may include an inner surface disposed between and connected to a pair of slanted walls that extend toward each other as they extend radially outwardly from the inner surface of the slot towards the outer periphery of the hub. The slanted walls may be coated with a lubricant, such as a dry film lubricant. The fan blade assembly may also include a plurality of fan blades. Each fan blade may include a dovetail shaped root that is received within one of the slots of the hub. Each dovetail shaped root may include an inner face disposed between and connected to a pair of slanted pressure faces that extend towards each other as they extend radially outwardly from the inner face. The inwardly slanted pressure faces may be at least partially covered with at least one wear mitigation pad.

In another aspect, a fan blade is disclosed. The fan blade may include a dovetail shaped root connected to an airfoil. The dovetail shaped root may include an inner face disposed between and connected to a pair of slanted pressure faces that extend towards each other as they extend from the inner face towards the airfoil. The inwardly slanted pressure faces may be at least partially covered with at least one wear mitigation pad.

In another aspect, a method for increasing the durability and wear resistance of a fan blade of a gas turbine engine is disclosed. The method may include providing a fan blade including a dovetail shaped root connected to an airfoil. The dovetail shaped root may include an inner face disposed between and connected to a pair of slanted pressure faces. The slanted pressure faces may extend towards each other as the slanted pressure faces extend from the inner face towards the airfoil. The method may further include at least partially covering the slanted pressure faces with at least one wear mitigation pad.

The disclosed method further includes providing a hub that may include an outer periphery with a plurality of dovetail shaped slots. Each dovetail shaped slots may accommodate one of the dovetail shaped roots of one of the fan blades. The method may further include applying a dry lubricant to each of the dovetail shaped slots.

In any one or more of the embodiments described above, the fan blade may be fabricated from an aluminum alloy or a titanium alloy. In any one or more of the embodiments described above, the hub may be fabricated from a titanium alloy.

In any one or more of the embodiments described above, the fan blade may be fabricated from an aluminum alloy and the hub may be fabricated from a titanium alloy.

In any one or more of the embodiments described above, the fan blade may be fabricated from a first alloy and the hub may be fabricated from a second alloy. The first alloy may have a hardness that is less than the second alloy.

In any one or more of the embodiments described above, the wear mitigation pad may be polymeric.

In any one or more of the embodiments described above, the wear mitigation pad may include a polyimide. In a further refinement of this concept, the wear mitigation pad may include VESPEL® or other high performance polymer materials, as will be apparent to those skilled in the art.

In any one or more of the embodiments described above, the dry film lubricant may include molybdenum disulfide (MoS₂), boron nitride (BN), graphite, or other solid lubricants that will be apparent to those skilled in the art. In a further refinement of this concept, the dry film lubricant may further include an epoxy, a silicone, a silicate, a phosphate or other binders known to those skilled in the art.

In any one or more of the embodiments described above, the lubricant is a dry lubricant coating that may have a thickness ranging from about 5 to about 75 microns.

In any one or more of the embodiments described above, the dry film lubricant may include EVERLUBE® 9002.

In any one or more of the embodiments described above, the wear mitigation pad may include VESPEL® and the lubricant may further include EVERLUBE® 9002.

In an embodiment, during engine operation, the dry film lubricant is burnished into the wear mitigation pad.

In any one or more of the embodiments described above, the at least one wear mitigation pad may include two wear mitigation pads that may include one wear mitigation pad disposed on each of the pressure faces. In a further refinement of this concept, each wear mitigation pad may extend from its respective pressure face to at least a portion of the inner face.

In any one or more of the embodiments described above, the at least one wear mitigation pad may extend from one of the pressure faces, around the root to the other of said pressure faces.

### BRIEF DESCRIPTION OF THE DRAWINGS

FIG. 1 is a sectional view of a gas turbine engine.

FIG. 2 is a perspective view of a disc shaped hub equipped with a plurality of dovetail shaped slots that extend through an outer periphery of the disc shaped hub and a single fan blade assembly with a dovetail shaped root that has been received in one of the dovetail shaped slots of the hub.

FIG. 3 is a perspective view of a fan blade assembly including a disc shaped hub equipped with a plurality of dovetail shaped slots that are circumferentially spaced around the outer periphery of the hub and that include dovetail shaped roots that are received within the dovetail shaped slots of the hub.

FIG. 4 is a partial exploded view of the fan blade assembly shown in FIG. 3, particularly illustrating the disc shaped hub, a partial view of one fan blade and one spacer that biases the fan blade in a radially outward direction.

FIG. 5 is a sectional view of the fan blade assembly shown in FIG. 3 as installed within an inlet case and behind a nose cone of a gas turbine engine.

FIG. 6A-6B are partial perspective views of a disclosed fan blade illustrating pressure faces of fan blade roots that are covered with disclosed wear mitigation pads.

FIG. 7 is another partial perspective view of a disclosed fan blade, illustrating the pressure faces of a fan blade root that are covered by wear mitigation pads that extend radially outward beyond the pressure face portion of the fan blade root and towards the airfoil.

FIG. 8 is yet another perspective view of a disclosed fan blade illustrating the pressure faces and inner face portions of the fan blade root that are covered by a wear mitigation pad.

FIG. 9 is a partial side view of a hub illustrating a dovetail shaped slot that has been coated with a disclosed lubricant material.

FIG. 10 is a partial perspective view of a disclosed hub illustrating two dovetail shaped slots that may be coated with a disclosed lubricant material.

### DESCRIPTION

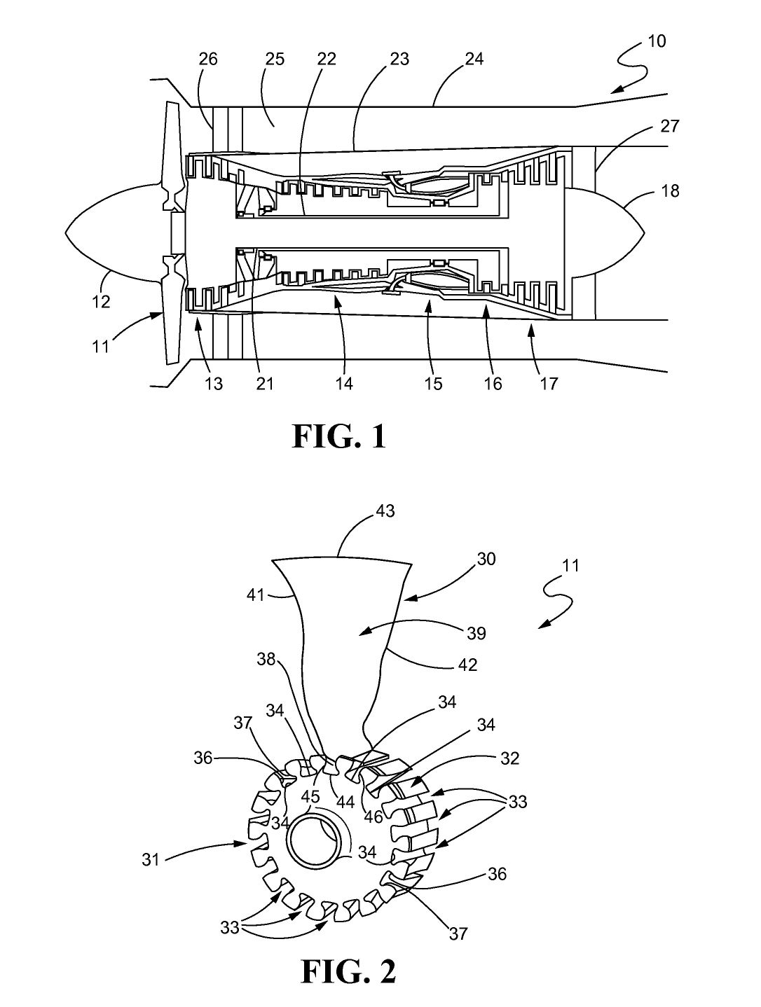

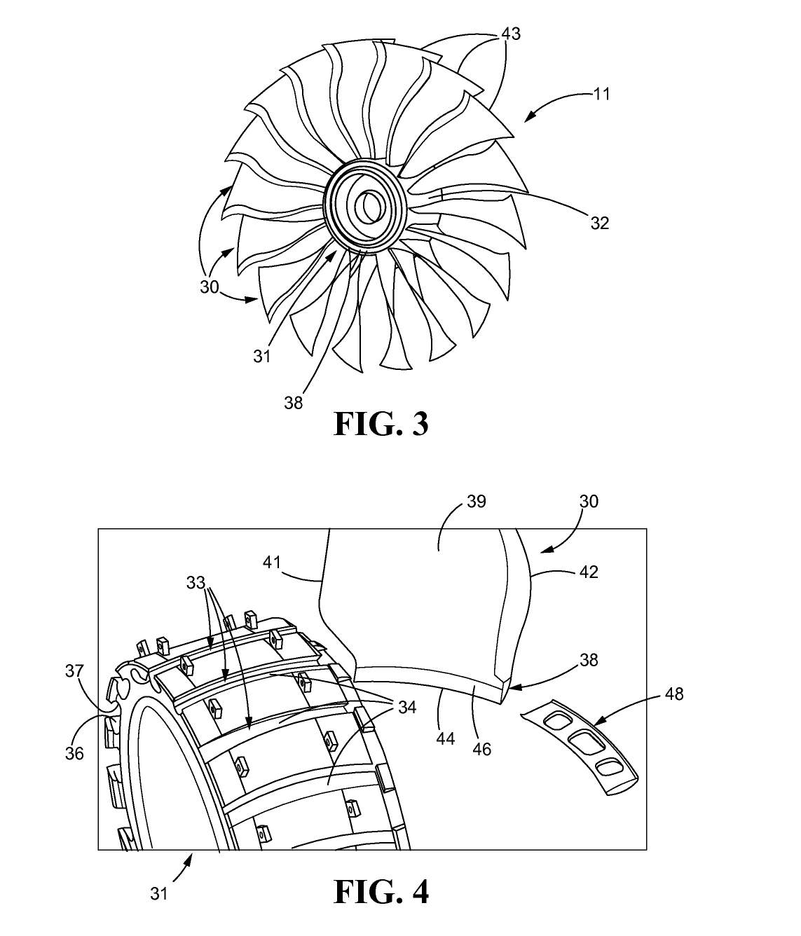

FIG. 1 is a sectional view of a disclosed gas turbine engine 10. The gas turbine engine 10 may include a fan assembly 11 that is disclosed in greater detail in connection with FIGS. 2-3. The fan blade assembly is mounted immediately aft of a nose cone 12 and immediately fore of a low pressure compressor (LPC) 13. A gear box (not shown) may be disposed between the fan blade assembly and the LPC 13. The LPC 13 may be disposed between the fan blade assembly 11 and a high pressure compressor (HPC) 14. The LPC 13 and HPC 14 are disposed fore of a combustor 15 which may be disposed between the HPC 14 and a high pressure turbine (HPT) 16. The HPT 16 is typically disposed between the combustor 15 and a low pressure turbine (LPT) 17. The LPT 17 may be disposed immediately fore of a nozzle 18. The LPC 13 may be coupled to the LPT 17 via a shaft 21 which may extend through an annular shaft 22 that may couple the HPC 14 to the HPT 16. An engine case 23 may be disposed within an outer nacelle 24. An annular bypass flow path may be created by the engine case 23 and the nacelle 24 that permits bypass airflow or airflow that does not pass through the engine case 23 but, instead, flows from the fan assembly 11, past the fan exit guide vane 26 and through the bypass flow path 25. One or more frame structures 27 may be used to support the nozzle 18.

Turning to FIG. 2, the fan blade assembly 11 may include a plurality of fan blades 30 mounted to a disc shaped hub 31. More specifically, the disc shaped hub 31 includes an outer periphery through which a plurality of dovetail shaped slots 33 extend. The dovetail shaped slots 33 include inner surfaces 34. The inner surfaces 34 are each disposed between inwardly slanted walls 36, 37 that extend inwardly towards each other as they extend radially outwardly from their respective inner surfaces 34. As also shown in FIG. 2, the dovetail shaped slots 33 may each accommodation a dovetail shaped root 38 of a fan blade 30. The dovetail shaped root 38 is connected to a blade 39 that includes a leading edge 41 and a trailing edge 42. The leading and trailing edges 41, 42 are disposed on either side of the blade tip 43. The dovetail shaped root 38 may include an inner face 44 that may be disposed between and connected to inwardly slanted pressure faces 45, 46. The pressure faces 45, 46 each engage the inwardly slanted walls 36, 37 respectively of their respective dovetail shaped slots 33.

Turning to FIG. 3, the hub 31 is shown with each slot 33 (FIG. 2) accommodating a root 38 of one of the fan blades 30. Turning to FIG. 4, an exploded/partial view of the hub 31, one fan blade 30 and a spacer 48 is shown. The spacer 48 may be disposed between the inner face 44 of the root 38 of the fan blade 30 and the inner surface 34 of its respective slot 33. The spacer 48 biases the root 38 of the fan blade 30 in a radially outward direction to assure a snug accommodating of the root 38 within its respective slot 33 during a windmilling of the fan blade assembly. The spacer 48 insures a snug contact between the pressure faces 45, 46 of the root 38 against the inwardly slanted walls 36, 37 of its respective slot 33 (see also FIG. 2) during windmilling when the centrifugal forces are relatively insubstantial.

In FIG. 5, a portion of the nacelle 24 is illustrated with a fan case 49 that surrounds the fan assembly 11. The hub 31 is shown as connected to the nose cone 12.

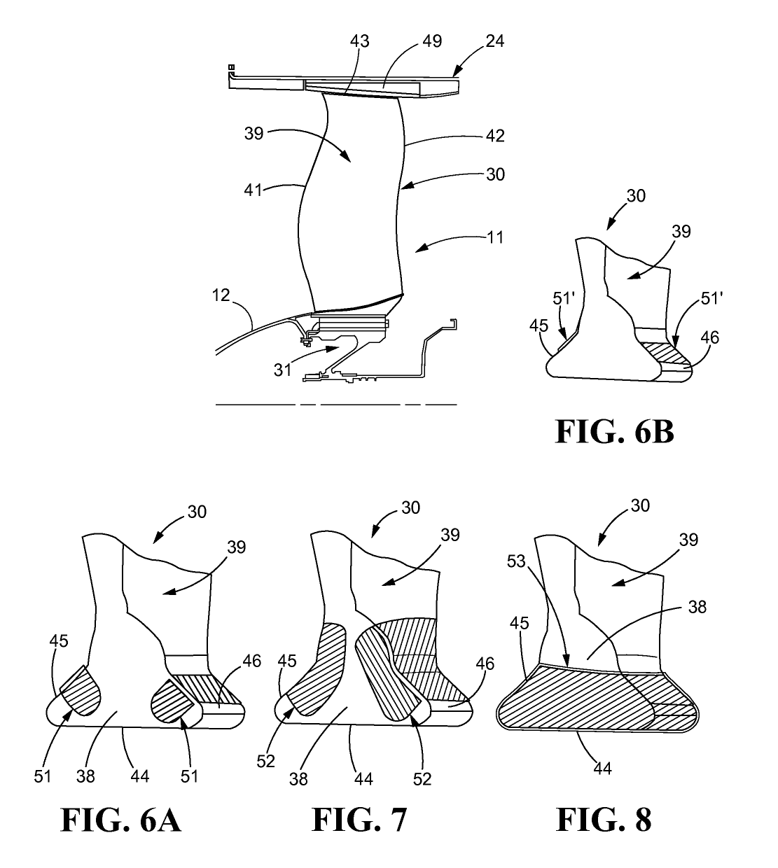

Turning to FIGS. 6A-8, as noted above, the inwardly directed pressure faces 45, 46 of the root 38 of the fan blade 30 may be covered with one or more wear mitigation pads 51, 51′ (FIGS. 6A-6B), 52 (FIG. 7), 53 (FIG. 8). The wear mitigation pads 51, 51′, 52, 53 prevent undue wear on the pressure faces 45, 46 of the roots 38 of the fan blades 30 during windmilling operations, particularly when the alloy used to fabricate the fan blades 30 is softer than the alloy used to fabricate the hub 31. For example, fan blades 30 are typically fabricated from an aluminum alloy. In contrast, hubs, like that shown at 31 herein are typically fabricated from a titanium alloy. Because titanium alloys are harder than aluminum alloys, in general, the roots 38 of aluminum fan blades 30 will wear faster than the slots 33 or the inwardly slanted walls 36, 37 of the slots 33 of a titanium hub 31. To mitigate the wearing of the pressure faces 46, 47, wear mitigation pads 51, 51′, 52, 53 may be utilized. In FIGS. 6A and 6B separate wear mitigation pads 51, 51′ are disposed on both pressure faces 45, 46. In FIG. 7, the wear mitigation pads 52 extend radially outward beyond the pressure faces 45, 46 and towards the blade 39. In contrast, in FIG. 8, the single wear mitigation pad 53 envelopes the pressure faces 45, 46 as well as the inner face 44 of the root 38.

The wear mitigation pads 51, 51′, 52, 53 may be fabricated from a polymeric material. In one embodiment, the polymeric material may be a polyimide. In a further refinement, the wear mitigation pad may be fabricated from VESPEL®, available from DuPont. VESPEL® is a range of durable high-performance polyimide-based plastics. VESPEL® is heat resistant, provides lubricity and creep resistance therefore making is suitable for the hostile and extreme environmental conditions to which a fan blade assembly 11 is exposed to. Other suitable polymers will be apparent to those skilled in the art.

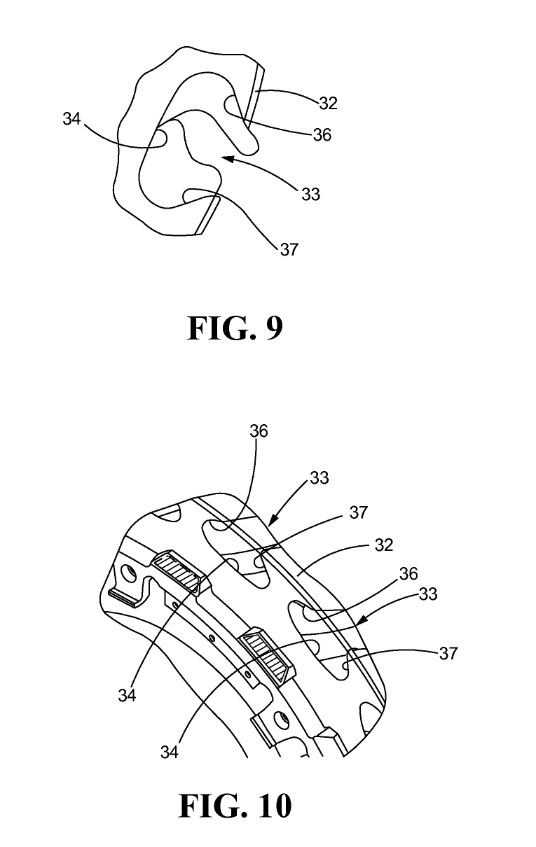

Turning to FIGS. 9-10, to further enhance wear mitigation, the slots 33 may be coated with a lubricant. Specifically, at least the inwardly slanted walls 36, 37 may be coated with such a lubricant. The lubricant may be in the form of a dry film lubricant. Further, the dry film lubricant should be compatible with both the fan blade roots 30 and the slots 33 in the hub 31. If utilized, the dry lubricant may include MoS₂, BN, graphite or other materials useful as dry film lubricants. In a further refinement, the dry film lubricant may include MoS₂ bound in a high molecular weight epoxy. Other binders include silicones, silicates, phosphates, etc. One suitable lubricant is available from Everlube Products (www.everlubeproducts.com). One preferred form of such a dry lubricant is EVERLUBE® 9002, which is a water based MoS₂ solid film lubricant. The lubricant may be applied to the slot 33 in the form of a dry film that has a thickness ranging from about 5 to about 75 microns. Other dry film lubricants that are compatible with titanium and/or aluminum include BN and graphite. Mixtures of lubricants may also be used. Suitable binders include epoxies, silicones, silicates, phosphates and combinations thereof.

### INDUSTRIAL APPLICABILITY

The combination of using one or more mitigation pads 51, 51′, 52, 53 in combination with coating the slots 33 and the hub 31 with a dry film lubricant, such as EVERLUBE® 9002, provides effective wear mitigation for a fan blade that is accommodated in a dovetail shaped slot 33 in a titanium hub 31. Using VESPEL® wear mitigation pads 51, 51′ on both pressure faces 45, 46 of a fan blade root 38 that was accommodated in a slot 33 coated with EVERLUBE® 9002 enabled the modified fan blade 30 to be operated for about 850 hours without exhibiting any wear on the loaded surfaces of the VESPEL® wear mitigation pads 51, 51′. The dry film lubricant tends to become burnished into the pad. As such, after the 850 hour time period, the fan blade 30 was found acceptable for future use. It was also concluded that the use of EVERLUBE® 9002 coating on the slot 33 did not cause any wear or distress to the VESPEL® wear mitigation pads 51, 51′. Accordingly, a wear mitigation system in the form of wear mitigation pads 51, 51′, 52, 53 in combination with a dry lubricant coated dovetail shaped slot 33 in a titanium hub 31 has been found to provide effective wear mitigation to the root 38 of an aluminum alloy fan blade 30.

1. A fan blade assembly comprising:
a disk shaped hub including an outer periphery including a plurality of circumferentially spaced dovetail shaped slots extending radially inwardly through the outer periphery of the hub;
each slot including an inner surface disposed between and connected to a pair of slanted walls that extend towards each other as they extend radially outwardly from the inner surface of the slot towards the outer periphery of the hub, the slanted walls being coated with a lubricant;
a plurality of fan blades, each fan blade including a dovetail shaped root received within one of the slots of the hub, each dovetail shaped root including an inner face disposed between and connected to a pair of slanted pressure faces that extend towards each other as they extend radially outwardly from the inner face, the inwardly slanted pressure faces being at least partially covered with at least one wear mitigation pad.

2. The assembly of claim 1 wherein the fan blade is fabricated from an aluminum alloy.

3. The assembly of claim 1 wherein the fan blade is fabricated from a titanium alloy.

4. The assembly of claim 1 wherein the hub is fabricated from a titanium alloy.

5. The assembly of claim 1 wherein the fan blade is fabricated from an aluminum alloy and the hub is fabricated from a titanium alloy.

6. The assembly of claim 1 wherein the wear mitigation pad is polymeric.

7. The assembly of claim 1 wherein the wear mitigation pad includes a polyimide.

8. The assembly of claim 7 wherein the wear mitigation pad includes VESPEL®.

9. The assembly of claim 1 wherein the lubricant includes a material selected from the group consisting of MoS₂, BN, graphite and combinations thereof.

10. The assembly of claim 1 wherein the lubricant further includes a binder selected from the group consisting of an epoxy, a silicone, a silicate, a phosphate and combinations thereof.

11. The assembly of claim 1 wherein the lubricant is a dry lubricant coating having a thickness ranging from about 5 to about 75 microns.

12. The assembly of claim 1 wherein the lubricant includes EVERLUBE® 9002.

13. The assembly of claim 1 wherein dry film lubricant is burnished into the wear mitigation pad.

14. The assembly of claim 1 wherein the at least one wear mitigation pad includes two wear mitigation pads including one wear mitigation pad disposed on each of the pressure faces.

15. The assembly of claim 14 wherein each wear mitigation pad extends from its respective pressure face to at least a portion of the inner face.

16. The assembly of claim 1 wherein the at least one wear mitigation pad extends from one of the pressure faces, around the root to the other of said pressure faces.

17. A fan blade comprising:
a dovetail shaped root connected to an airfoil, the dovetail shaped root including an inner face disposed between and connected to a pair of slanted pressure faces that extend towards each other as the slanted pressure faces extend from the inner face towards the airfoil, the slanted pressure faces being at least partially covered with at least one polymeric wear mitigation pad.

18. The fan blade of claim 17 wherein the wear mitigation pad includes a polyimide.

19. A method for increasing durability and wear resistance of fan blades of a gas turbine engine, the method comprising:
providing a plurality of fan blades, each fan blade including a dovetail shaped root connected to an airfoil, each dovetail shaped root including an inner face disposed between and connected to a pair of slanted pressure faces that extend towards each other as the slanted pressure faces extend from the inner face towards the airfoil;
at least partially covering the slanted pressure faces with at least one wear mitigation pad.

20. The method of claim 19 further comprising providing a hub including an outer periphery with a plurality of dovetail/slots, each dovetail shaped slot accommodating one of the dovetail shaped roots of one of the fan blades; and applying a dry lubricant to each of the dovetail shaped slots.
